(19) United States
(12) Patent Application Publication
(10) Pub. No.: US 2025/0187118 A1
(43) Pub. Date: Jun. 12, 2025

(54) DYNAMICALLY CONTROLLED LASER DRILLING SYSTEM AND METHOD FOR PRODUCING HOLES

(71) Applicant: IPG PHOTONICS CORPORATION, Marlborough, MA (US)

(72) Inventors: Marco BIANCHI, Milan (IT); Marco FRANZOSI, Milan (IT); Luca LONGONI, Milan (IT); Matteo CAPRA, Milan (IT); Francesco MAZZOCCHIN, Milan (IT)

(73) Assignee: IPG PHOTONICS CORPORATION, Marlborough, MA (US)

(21) Appl. No.: 18/844,184

(22) PCT Filed: Mar. 7, 2023
(86) PCT No.: PCT/US2023/014677

§ 371 Date: Sep. 5, 2024

Related U.S. Application Data
(60) Provisional application No. 63/317,220, filed on Mar. 7, 2022.

(51) Int. Cl. B23K 26/388; B23K 26/06; B23K 26/073; B23K 26/08; B23K 26/10

(52) U.S. Cl. CPC B23K 26/388; B23K 26/0643; B23K 26/0734; B23K 26/083; B23K 26/0869; B23K 26/103

(57) ABSTRACT

A laser drilling system is configured with a combination of system components including a fiber laser source, laser processing head, dynamic compensator, configured with one or multiple galvanometers, and stage supporting the workpiece to be laser drilled. The system components are all functionally coupled to one another to provide a plurality of trepanned holes in the workpiece each with the desired geometry. The laser head and stage are continuously displaceable relative to one another while the dynamic compensator pivots so as to keep the laser spot and the predetermined drilling location stationary relative to one another over a predetermined period of time sufficient for drill the hole. The laser source is selected from solid-state lasers configured with a single core or multi-core delivery fiber. The multicore delivery fiber is associated with adjustable mode beam (AMB) lasers to provide annular, polygonal or irregular holes.

### BACKGROUND OF THE DISCLOSURE

### Technical Field

The present disclosure relates to laser drilling systems. In particular, the disclosure relates to a laser drilling system configured with a dynamic compensator which is configured to controllably produce a variety of hole geometries.

### Background of the Disclosure

innumerous industries including, among others, industrial machining, airspace, industrial recycling, airspace, food processing, waste management, water treatment and air and gas filtration use parts manufactured with a variety of perforations or holes. The manufacturing processes for producing perforations, for example, in metals have unique challenges and limitations when the holes are punched, mechanically drilled, or created through a workpiece stretching process. Each of these processes may create residual mechanical stresses that can lead to warpage (twisting or cupping) of the workpiece. Typically, these undesirable effects are corrected through a secondary operation.

An alternative method to perforating workpieces involves the use of a laser in general and particularly fiber laser. The latter can produce the holes with precision and speed while minimizing the residual stresses in the filter workpiece to be laser manufactured. The fiber laser drilling process dramatically expands the drilling design options. The holes can be round, square, oval, tapered, angled, or have a custom geometry. The workpiece surface can be flat, circular, or a complex 3D shape. Because the laser is an integral part of multi-axis machines, various perforations can be applied to a variety of 3D surfaces. This enables the perforations to be placed and shaped as required to help optimize the laser drilling process.

There are different drilling techniques: single shot, multishot or percussion and trepanning. FIGS. 1, 2A and 2B illustrate an exemplary single shot technique in accordance with which a single pulse 26 produces a hole. This technique provides very high drilling frequencies (holes per second) and thus a high throughput. Moreover the single shot technique allows to “drill on the fly” which includes continuous hole production without interrupting the displacement of workpiece 26 (FIG. 2A) and laser head 14 relative to one another which dramatically reduces the waste of time related to the inertia associated with the starts and stops. It is important that the “laser on” time (or laser pulse width) is short enough so that the workpiece support or stage movement during a laser pulse width doesn't induce a deformation in hole circularity due to relative movement between the laser head and thus the laser beam and the workpiece, as explained below.

A laser drilling system 10 typically includes a laser source 12 (FIG. 1), processing laser head 14, processor 16, interface 18 between processor 16 and workpiece supporting stage 38 (FIG. 2A), and transport and gas delivery systems, respectively (not shown) if required by specific drilling process. The desired velocity of the laser head, peak power and pulse duration as well as pulse repetition rate are predetermined and stored. All of the above individual elements or any combination thereof—laser source 12, laser head 14, interface board 18, processor 16, which may function both as a system controller and laser head processor and can be referred to as a central processing unit (CPU), and workpiece supporting stage 38 are housed in a laser cube or housing 20 (FIG. 1). Alternatively, system 10 is provided with a CPU 22 mounted to laser cube 20 and configured to control numerous parameters of system 10 including, for example, the velocity at which laser head 14 and/or stage supporting the workpiece to be laser treated are displaced relative to one another. In this configuration, processor 16 is designated to control only laser head 14 and is in communication with CPU 22.

One of the most typical drilling operations relates to drilling the holes in workpiece used for fabricating a variety of filters. To initiate the operation of system 10, the laser parameters including a peak power Pp, pulse duration and pulse repetition or drilling rate are empirically or theoretically predetermined and stored in the memory of CPU 22. In response to the signal from CPU 22, either stage 38 (FIGS. 2A and 2B), supporting the target workpiece, or laser head 14 or both the stage and laser head are actuated to provide continuous displacement of laser head 14 and workpiece 26 relative to one another. Assuming laser head 14 is movable, at a certain point of time it reaches a predetermine position corresponding to one of locations 28 to be drilled. At this point, in response to a control signal from processor 16 (or CPU 22) coupled into laser source 12, the latter outputs a laser beam including a pulse 25 (FIG. 2A) which is incident on beam guiding optic 24 fixed to laser head 14. The beam guiding optic 24 further deflects the laser beam towards one of locations 28. As it all happens, laser head continues its displacement with the beam spot inevitably dragging in direction D of the laser head's displacement. Accordingly, assuming pulse 25 is characterized by the desired peak power, it drills a hole at location 28.

During the time corresponding to the pulse duration, laser head 14 is displaced in direction D (FG. 2A) from position 25a(FIG. 2B) through intermediate positions 25b and 25c before it arrives at position 25d which corresponds to the end of the pulse duration. The continuous displacement of laser head 14 with beam guiding optic 24 (FIG. 2A) during a time interval corresponding to the duration of single pulse 25 results in an elongated or oval hole 28 drilled in target workpiece 26. The elongation of hole 28 is the result of beam optic 24 following the displacement of laser head 14 and thus dragging the beam spot along a linear path. When the current hole is produced, laser source 12 (FIG. 1) is de-energized, while laser head 14 and/or stage 38 keep moving toward the next location. The above-described operation continues until each of the marked locations is laser treated.

The hole characteristics (inner diameter, outer diameter, conicity) directly depends on laser parameters like peak power, pulse width, process gas pressure and system characteristics such as nozzle width an others. A physical relationship between the hole volume and energy density can be found experimentally. Bigger holes and thicker workpieces require more energy input to produce a hole. Two laser parameters are directly correlated with pulse energy: peak power and pulse width. The product of these two parameters gives the total amount of pulse energy. To increase the pulse energy (for larger holes and/or for thicker workpieces) either the peak power should be increased, provided that the pulse width remains unchanged, or, with the peak power unaltered, the pulse width should be increased. The increased peak power requires laser sources with overall higher powers which entail higher production and maintenance costs, whereas the increased pulse width leads to the hole's deformation known as the “hole ovalization”, as disclosed in the previous paragraph. The latter is problematic for many applications. For example, if the workpiece to be laser drilled is a filter, the ovalization destroys the uniformity of the perforations. The hole's asymmetry detrimentally affects the filtering characteristics lowering thus the filter's efficiency. To avoid ovalization it is necessary to reduce the velocity at which the workpiece and laser head are displaced relative to one another. The decreased velocity translates into the decreased drilling frequency which, in turn, leads to the reduced machine throughput. As has been experimentally determined to prevent the hole asymmetry, the drilling frequency should be reduced to 5-7 Hz which is too low to make a production economically sustainable.

The filter for plastic recycling machines may have up to 3 million holes (depending on holes size and pitch—the smaller the hole size, the larger the total number of holes). For such a filter to be competitive, its total manufacturing process should not exceed 6-7 hours. Beyond this time limit the filter production cost is economically unjustified.

If the hole diameter varies between about 80 to 100 um and stainless steel thickness is at most 1 mm, the drilling frequency of 250 Hz may be sufficient for producing 3 million holes in about 6 hours at a few kW peak power. For bigger holes, such as 1000 um dimeter hole, drilled in 2 min thick stainless steel, obviously the peak power should be increased to complete the process within 6 hours. In the example with a 1000 um hole diameter, the filter typically has about 250.000 holes, which means that a total process time for completing a single filter at a 5 Hz frequency—the frequency necessary to prevent the hole ovalization—exceeds 15 hours. It is possible to increase a peak power and reduce pulse width to get the same pulse energy needed to efficiently drill a 1.000 um hole, but it requires the drilling frequency of at least 40 Hz for a sustainable production. At the 40 Hz drilling frequency, the pulse width should not exceed 3 ms to avoid hole ovalization which, in turn, requires a 47 kW peak power to have same the pulse energy. But the 47 kW peak power requires a 50 kW laser source which is too expansive and again economically unjustifiable.

A need therefore exists fora laser drilling system operating at an output power and drilling frequency which meet the throughput and production cost in accordance with the market requirement while producing the desired high number of uniform round holes.

Still another need exists for the above-mentioned laser drilling system configured to controllably drill holes having a variety of geometries.

### BRIEF SUMMARY OF THE DISCLOSURE

These needs are satisfied by the disclosed laser drilling system which is characterized by a laser source, laser head, transport, system or multi-axis stage and, in some embodiment, delivery fiber system. The laser source may include a variety of solid body lasers, such as fiber lasers operating in a quasi-continuous wave (QCW) or pulsed regime. The laser outputs a train pulses each of which is characterized by a peak power and pulse duration that provide the desired high hole drilling frequency meeting the market requirements to a throughput and production cost. However, in contrast to the known prior art, the drilled holes/perforations in the workpiece have no ovality or noncircularity, which is the amount of the hole's out-of-roundness. Added to the above-disclosed laser drilling system the beam delivery system configured to controllably adjust beam modes/shapes expands the possibilities of the inventive system by allowing the elater to produce a variety of hole geometries.

In accordance with one salient feature, the hole's roundness is preserved by adjusting a stationary beam spot at each of the predetermined hole locations on the target workpiece for a time period sufficient to drill a round hole while continuously displacing the laser head relative to the target workpiece along a path. Technologically, a single or more galvo mirrors are mounted in the laser head and actuated to guide the laser beam so that it is incident on the desired location of the workpiece for the predetermined time period while the laser head keeps continuously moving or the workpiece on the stage is moving or both the laser head and workpiece are moving. In other words, the beam spot and the location to be irradiated are spatially and temporally fixed relative to one another during drilling the hole. In summary, in a system, including the laser, laser head, workpiece support/stage and galvo mirror, the position between the beam spot and workpiece's location to be irradiated is fixed for the predetermined period of time sufficient to drill the desired round hole provided, of course, the peak power is correctly determined.

In accordance with another salient feature of the invention, the above disclosed drilling system is further configured with a fiber delivery system which is structured to controllably output differently shaped beams. Combined with the disclosed galvo mirrors, this structure allows for producing innumerous hole geometries including the round holes.

### BRIEF DESCRIPTION OF THE DRAWINGS

The above and other structurally and conceptually complementary features will become more apparent with reference to the accompanying figures, which are not drawn to scale. The figures provide an illustration and a further understanding of the various intertwined aspects and schematics, and constitute a part of this specification, but do not represent the limits of any particular schematic or aspect. In the drawings, each identical or nearly identical component that appears in various figures is denoted by a like numeral. For purposes of clarity, not every component may have the same reference numeral. In the figures:

FIG. 1 illustrates a general layout of the laser drilling system;

FIGS. 2A and 2B are respective optical and operation illustrations of the known laser drilling system of FIG. 1;

FIGS. 3A and 3B are respective optical and operation illustrations of the inventive principle of the laser drilling system of FIG. 1;

FIGS. 4A-4C illustrate respective optical schematics illustrating the initial drilling step, final drilling step in accordance with the known art and final drilling step in accordance with the inventive concept;

FIG. 5A illustrates a cylindrical hole produced by the inventive fiber laser system of 11G. 4C which outputs a laser beam with a fixed beam diameter;

FIG. 5B illustrates a tapered hole produced by the inventive fiber laser system of FIG. 4C which outputs a laser beam with an adjustable beam diameter;

FIGS. 6A-6C illustrate an exemplary adjustable mode beam (AMB) laser system; and

FIGS. 7A-7J illustrate exemplary hole geometries producible by the inventive laser system of FIGS. 1, 3A-3B and 4C.

### SPECIFIC DESCRIPTION

The inventive concept relates to a laser system for treating workpiece and including at least three elements which are displaceable relative to one another so that the laser beam is incident on the workpiece at a controllable angle of incidence. In particular, the inventive laser drilling system implements the drill on fly technique to produce innumerous substantially uniform round holes at the drilling rates meeting the market requirements. Associated with the known prior art problem of hole elongation is solved by a dynamic compensator mounted to the laser head of the inventive system. The dynamic compensator is configured to controllably guide a laser beam in a direction opposite to the direction of continuous displacement of the laser head and/or stage supporting the workpiece. The beam is trained on the desired location to be drilled of the workpiece. According to the inventive concepts, every time the pulse at the predetermined peak power is generated, the beam spot and the irradiated location are in a fixed spatial and temporal relationship for the pulse duration which is sufficient to produce a round hole. Based on the foregoing, the inventive system utilizes the drill on fly technique allowing a high throughput of round holes in a cost efficient manner which meets and exceeds the market requirements.

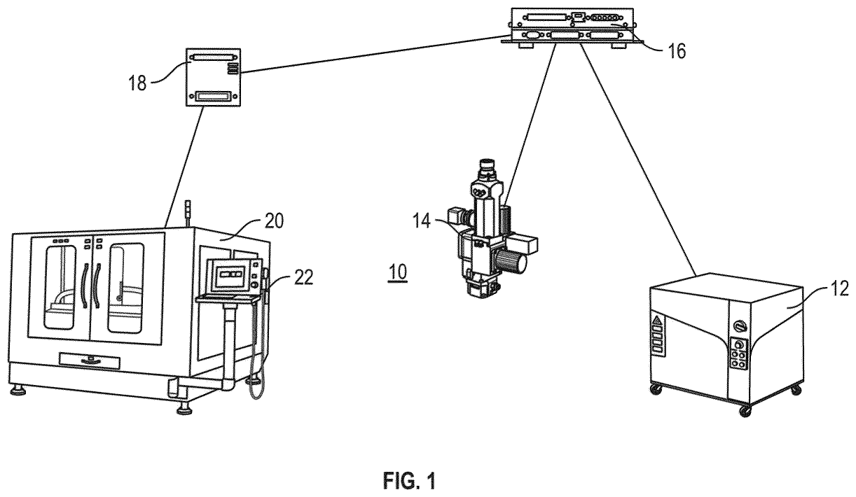

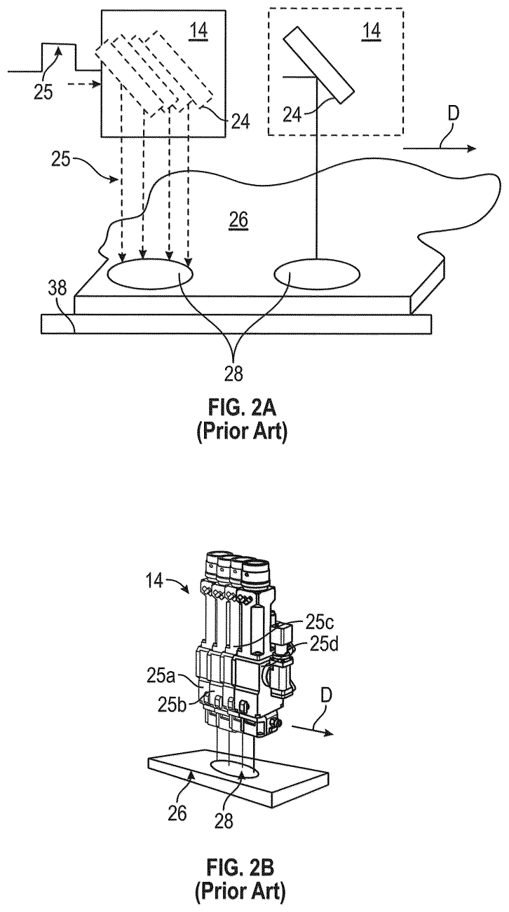

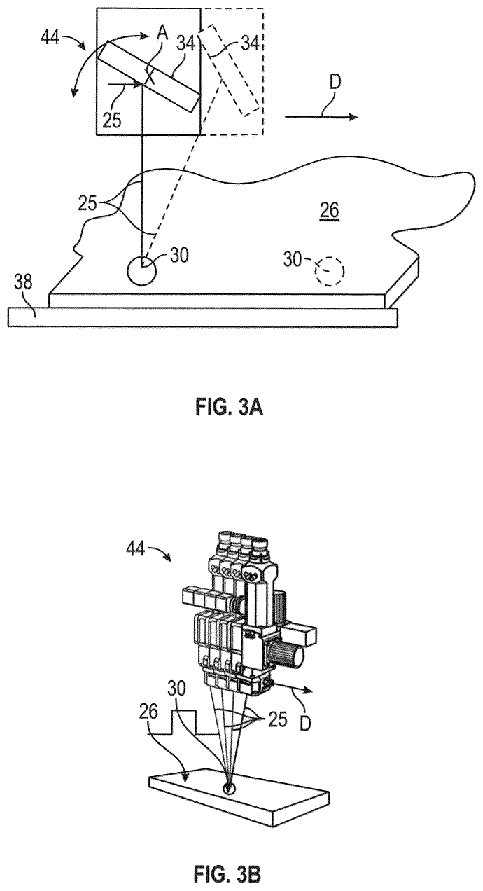

Referring to FIG. 1 and FIGS. 3A and 3B, the above disclosed laser drilling system 10 of FIG. 1 has been improved by incorporating a single or multi-axis galvo mirror system 34 (FIG. 3A) in a wobble laser head 44. Gyroscopes are critical rotational elements incorporated in a variety of beam guiding, navigation and other systems. Similar to beam guiding optic 24 (FIG. 2A) of the known art, galvo mirror system 34 is displaceable along a linear path with wobble laser head 44 relative to the X-Y-Z stage 38 propping and guiding workpiece 26. Unlike beam guiding optic 24 of FIG. 2A, galvo mirror system 34 controllably pivots about an axis A which extends transversely to the horizontal and vertical propagation planes (relative to the sheet) of laser beam 25. The angular displacement of galvo mirror system 34 is shown by a double-head arrow and characterized by two fixed spaced positions—the initial or first one shown in solid lines and final or second position in phantom lines. The linear distance between the initial and final positions corresponds to the distance covered by wobble laser head 44 during the pulse duration. The galvo mirror system 34 starts pivoting once laser head 14 reaches the predetermined position which, in time domain, coincides with the generation of pulse by laser source 12 and corresponds to the initial position of mirror 34. At the end of the single pulse duration, galvo mirror 34 reaches its final angular position. During the pulse duration the beam spot and location/hole 30 are spatially fixed relative to one another. The peak power, pulse duration, drilling frequency, laser head velocity, angular speed ω of mirror 34 (where ω=θt, θ is the angle of rotation) and other parameters are selected to produce a round hole. However, as one of ordinary skill in the mechanical arts realizes, the parameters may be controlled to produce holes having various geometries. For example, controlling these parameters it is possible to produce different types of annular holes. Utilizing a variety of beam shapers, other hole geometries may include polygonal or angled holes.

As wobble laser head 44 continues to move indirection D during the pulse duration, galvo-mirror system 34 continuously pivots beam 25 about axis A in a direction opposite to the displacement D of wobble laser head 44 thus controllably changing the beam's angle of incidence. As a result, the beam spot and location/hole 30, which is larger than the beam spot, remain stationary relative to one another. Accordingly, hole 30 has no elongation and is substantially round. At the termination of the pulse, galvo mirror system 34 pivots back to its initial position while wobble laser head 44 continues its displacement toward the next location to be drilled, and the above-disclosed operation is repeated for each of the predetermined locations. Note that displacement of laser head 44 may be arrested, and the above-disclosed operation can be based on the displacement of the stage with workpiece 26 in the direction opposite to that indicated by arrow D.

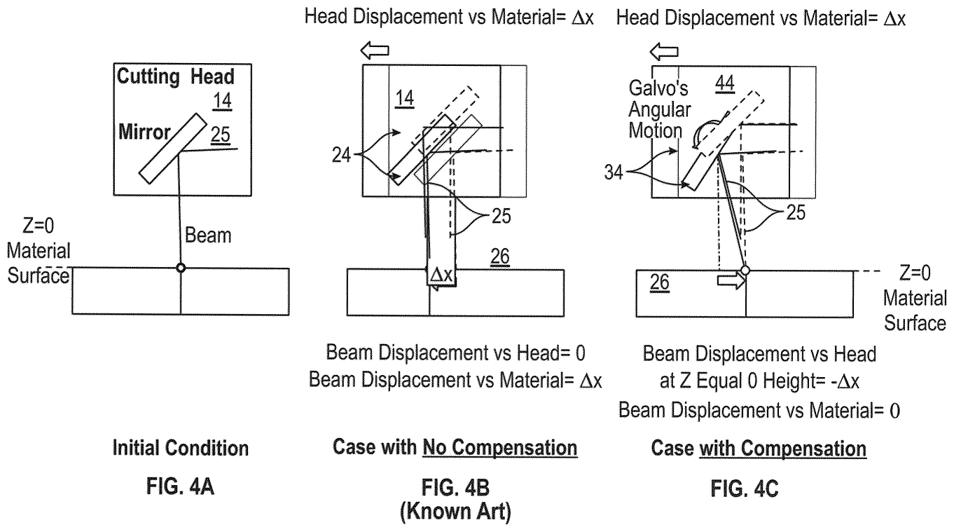

FIGS. 4A-4C provide visual comparison between the drilling operation of respective prior art drilling systems (FIG. 4B) and inventive system (FIG. 4C). In both, the known and inventive laser drilling systems, beam 25 is incident on the mirror during a pulse duration, as indicated in FIG. 4A while wobble laser head 44 and stage propping the workpiece 26 move relative to one another. In the known system of FIG. 41, beam 25 and workpiece 26 are also displaced relative to one another at a distance Δx (which corresponds to the length of the displacement between the laser head and workpiece)—the motion which results in an oval hole. The reason for such a relative motion between beam 25 and workpiece 26 is the fixed angular position between beam-guiding optic 24 and wobble laser head 44 which drags the beam spot along a linear path irradiating a length of workpiece 26. Hence the hole is oval. The above statement is based on the laser source selected to output a pulse peak power that would make the inventive system financially appealing to the relevant market.

In contrast, as shown in FIG. 4C, the angular displacement of inventive galvo-mirror system 34, changes the angle of incidence which pivots laser beam 25 in a direction opposite to the displacement direction of laser head 44 for the entire duration of the pulse. However, the beam spot and workpiece 26 remain stationary relative to one another which results in a round hole since the beam spot irradiates the same very location of workpiece during the entire pulse duration.

The above description mainly referred to the movable laser head. However, as one of ordinary skill readily realizes, making the laser head stationary and stage/workpiece movable does not change the relationship between galvo mirror system 34 and workpiece 26. In particular, during the pulse duration, galvo mirror system 34 pivots beam 25 in the direction opposite to the stage movement and at the same axis speed. With this parameters, interaction point between laser beam 26 and the workpiece's surface is always the same during pulse width/pulse duration, with the relative speed between the beam spot and location being exactly equal to zero.

Alternatively, both the laser head and workpiece can move simultaneously provided the direction and desired speed ratio between laser head 44 and workpiece 26, angular speed of the galvo system and angle at which it pivots along with a preset drilling frequency are properly selected and controlled which can be realized by one of ordinary skill in the mechanical/laser/software combination of arts. Furthermore, while the e inventive disclosure targets round holes, one of ordinary skill readily realizes that all of the above-disclosed parameters can be controlled to produce various hole geometries, such as an 8-shaped hole. Furthermore, while the diagrammatically illustrated example of the disclosed system is configured with galvo mirror system 34 pivoting beam 25 against the direction of the laser head's displacement D, it can be reconfigured to pivot beam 25 in the opposite direction.

Thus, the dynamic compensation is performed by a single or multiple galvanometer mirrors 34 mounted in drilling wobble head 44. During the pulse duration, galvo mirror 34 will make a linear trajectory in opposite direction respect to axis movement and at the same axis speed. The line length is directly related to the pulse width, so that time required for galvo mirror 34 to make the line at a certain speed is exactly the same of laser pulse width. With this rs, the interaction point between laser beam 25 and workpiece surface is always the same during the pulse duration, with relative speed (between the beam spot and workpiece) being exactly equal to zero. In this way the hole is drilled as if process/laser head 44 and workpiece 26 are steady and fixed. The laser source 12 of FIG. 1, can operate in a QCW or pulsed regime and be configured as a solid state laser including fiber lasers. As mentioned above, the laser beam emission is controlled by wobble head controller 16 or CPU 22, so that the laser emission is activated at the pivoting start point, while is stopped at the very end of it. Once the hole is completed and laser emission is off, galvanometer returns to the initial position to only be activated upon drilling the next hole. Process is repeated for each hole to produce.

Based on the foregoing, use of the inventive wobble head increases the overall throughput drilling of holes with diameters ranging from a beam size to near nozzle size which roughly corresponds to a 0.1-3 mm hole diameter range produced in up to 5 mm thick materials. The tests also proved a good dimensional accuracy/repeatability and reduced spatter at a minimum laser cost. The tests also showed a high throughput of 10's of holes/sec. Some of the tests resulted in 15-20 1 mm holes per second in a 3 mm thick stainless steel. Based on the results obtained during numerous tests, the wobble drilling is at about 5-10 times faster than gantry trepanning of 3 mm thickness stainless steel. More than 50 holes per second can be produced with the reduced hole size and material thickness smaller than 2 mm. The wobble drilling has been observed to have a minimal dross at the exit and practically no spatter on top. Also, cutting off-center of the nozzle did not negatively affect the hole roundness.

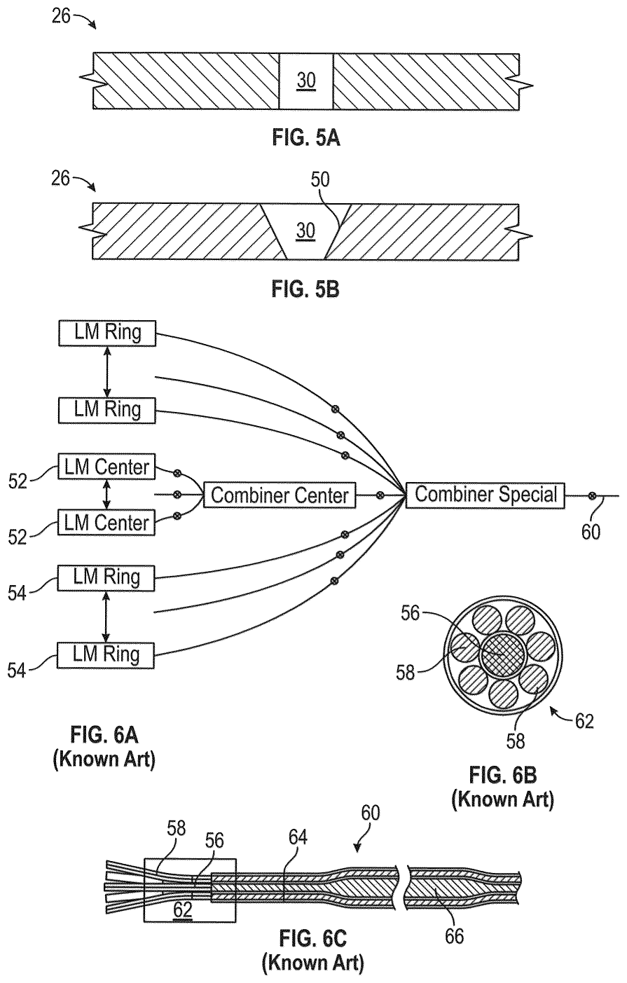

FIGS. 5A and 5B illustrate another salient feature of the inventive laser system generally shown in FIGS. 1, 3A and 31. In particular, laser drilling system 10 of FIG. 1 is configured with an AMB laser source characterized by delivery system which alters the beam shape/mode of the system's output. As mentioned above, high power laser 12 of system 10 for trepanning holes may operate in the QCW regime with a duty cycle ranging between 1 and 99%, and the pulsed regime. Typically, laser 12 outputs beam 25 which is characterized by a single beam shape or profile, such as a ring-shaped beam with a Gaussian intensity distribution profile. The laser system 10 typically has a delivery fiber guiding laser beam 25 of FIG. 3A through its core such that it irradiates a single spot on the surface of the workpiece. As a result, system output beam 25 drills holes 30, which are typically through going within the web of workpiece 26. Each hole 30 is defined by a peripheral wall which is substantially cylindrical, as shown in FIG. 5A. As a consequence, holes 30 each are round. Some applications benefit from thus produced round uniformly dimensioned holes. Others do not.

For example, the filtering applications are in need of tapered round holes shown I FIG. 5B. To meet this need, the inventive system includes a combination of wobble head 44 (FIG. 3A) and double-clad delivery fiber 60 of FIGS. 6A and 6C, the combination which allows the output system beam to have at least two or more different modes. Multiple tests showed that such combination enables the production of tapered holes of FIG. 5B. The AMB laser system, such as laser systems manufactured by IPG Photonics Corporation, is configured to switch the beam mode between ring-shaped and donut-shaped beams.

The exemplary AMB laser is disclosed in WO 2020/117816 (WO '816), commonly owned by the same Assignee and incorporated herein by reference in its entirety, is generally shown in FIGS. 6A-6C. The disclosed AMB laser includes a power source which is configured with a single or multiple central lasers 52 (FIG. 6A) and a plurality of peripheral lasers 54. Output fibers 56 and 58 of respective central and peripheral lasers are combined in a combiner 62 (FIG. 6B) which is fused to double-clad delivery fiber 60 of FIG. 6C. The latter may have a uniformly dimensioned cross-section, but more frequently it has a double bottleneck-shaped cross-section includes fiber ends having respective diameters which each is smaller than that one of the central fiber region extending between the fiber ends. The delivery fiber 60 thus has two waveguiding double bottleneck-shaped cores 66 and 64 respectively. The central core 66 outputs a ring-shaped beam received from central output fiber 56 of combiner 62 and generated by centrally located laser or lasers 52 of FIG. 6A. The outer core 64 receives light generated by peripheral lasers 54 via respective peripheral combiner's output fibers 58. If only the peripheral lasers 54 operate, then the output beam has a donut shape, whereas when only central laser or lasers 52 operates, the output beam is ring-shaped. Obviously, another operational mode includes simultaneous operation of all lasers 52 and 54 together. Varying number of the lasers and respective output powers of central and peripheral lasers 52, 54 respectively, a different power ratio of respective ring and donut beams is easily adjusted.

To produce tapered holes with the AMB laser, the displacement of galvo-mirror unit 44 is first pre-programmed to follow the predetermined displacement trajectory corresponding to the selected hole geometry. Facilitating the formation of the latter, the lasers are controlled to output light which is either delivered to the workpiece through the core, cladding or core and cladding of delivery fiber 60 of FIG. 6C. For example, gradually reducing the power of peripheral lasers 54 while adjusting the power of central laser(s) 52 not only trepans the workpiece forming thus a tapered annular peripheral wall 50 which defines tapered hole 30 of FIG. 51B, but also allows controlling the taper angle. Alternatively, peripheral lasers 54 can be completely de-energized after the initial large-diameter portion of tapered hole 30 on the irradiated surface of the workpiece is drilled. The remaining portion of tapered hole 30 is completed by controlling the power of central laser(s) 52. Of course, the inventive trepanning system configured with the AMB laser can produce perfectly cylindrical holes if desired.

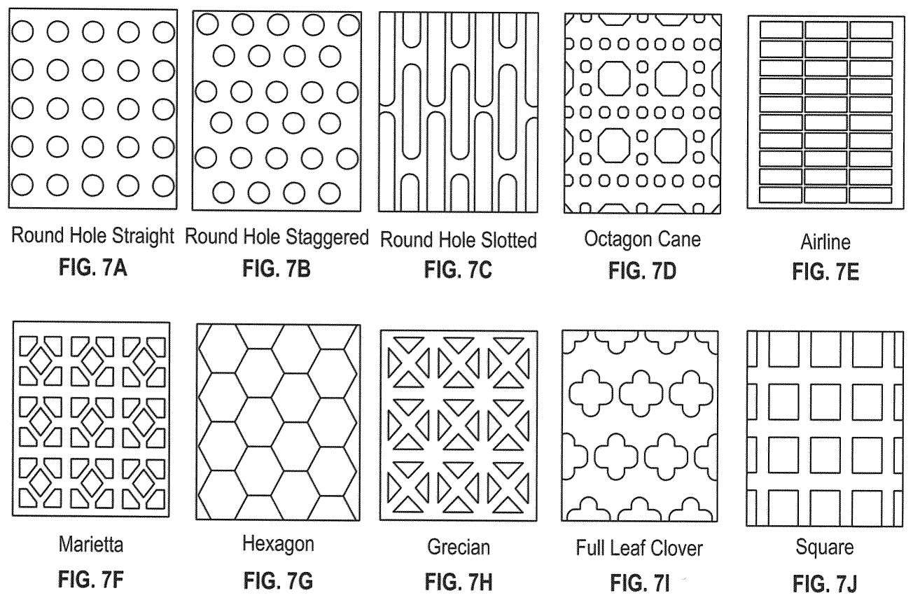

In fact, inventive system 10 provided with the AMB configuration allows obtaining numerous hole geometries including, but not limited to those shown in FIGS. 7A-7J. Practically any desired hole geometry can be trepanned by inventive laser drilling system 10 which requires programming the operation of galvo-mirror unit 34 of FIG. 3A and controlling the output power of central and peripheral lasers of FIG. 6A Of course, pulse frequency and other pulse parameters should be carefully selected to meet the industrial demands. As can be seen, the hole geometry can be annular and include round, oval and slotted holes shown in respective FIGS. 7A, 7B, 7C. The hole geometry can be polygonal and include octagonal, hexagonal, rectangular, square and other polygonal hole formations, as shown in respective FIGS. 7D, 7G, 7J. Irregular hole geometries are also obtainable as exemplified by Marietta, Grecian and leaf Clover holes geometries illustrated in respective FIGS. 7F, 7H and 7I. Other hole geometries, such as elliptical holes, is also easily realizable by the inventive system provided with the AMB configuration. The drilled holes can be arranged in a variety of patterns based on the pre-programmed relative displacement between wobble laser head 44 and stage 38 of FIG. 3A. For example, FIGS. 7A and 7B illustrate respective round hole straight and round hole staggered patterns.

As one of ordinary skill realizes, the above discussed configuration is exemplary and alternative optical configurations operative to adjust beams modes may be successfully used within the scope of this invention.

With this method process machine throughput is in line with market requirements, with processing frequencies of up to 10 times more than that of standard process without compensation shown in FIGS. 2A-2B and 43. The overall investment cost of inventive system 10 is in line with market requirements with laser power levels not exceeding several kilowatts.

The aspects disclosed herein in accordance with the present invention, are not limited in their application to the details of construction and the arrangement of components set forth in the following description or illustrated in the accompanying drawings. These aspects are capable of assuming other embodiments and of being practiced or of being carried out in various ways. Examples of specific implementations are provided herein for illustrative purposes only and are not intended to be limiting. In particular, acts, components, elements, and features discussed in connection with any one or more embodiments are not intended to be excluded from a similar role in any other embodiments.

Also, the phraseology and terminology used herein is for the purpose of description and should not be regarded as limiting. References in the singular or plural form are not intended to limit the presently disclosed systems or methods, their components, acts, or elements. In addition, in the event of inconsistent usages of terms between this document and documents incorporated herein by reference, the term usage in the incorporated reference is supplementary to that of this document; for irreconcilable inconsistencies, the term usage in this document controls.

Having thus described several aspects of at least one example, one of ordinary skill in the art readily appreciates that various alterations, modifications, and improvements will readily occur to those skilled in the art. For instance, examples disclosed herein are applicable in other contexts. Such alterations, modifications, and improvements are part of this disclosure. Accordingly, the foregoing description and drawings are by way of example only.

1. A laser drilling system for trepanning a plurality of holes in a workpiece, comprising:
a laser source outputting a pulsed laser beam controllably incident on a plurality of locations on a surface of workpiece which correspond to respective holes to be drilled, each pulse having a peak power and pulse duration which are predetermined to drill the hole;
a laser head located between the laser source and workpiece and configured with a galvo mirror unit which is fixed to the laser head and configured to guide the pulsed beam so that it forms a beam spot at each location during the pulse duration; and
a stage supporting the workpiece so as to provide continuous displacement between the workpiece and laser head as the galvo mirror unit controllably pivots between first and second positions at each location during the pulse duration so that an angle of incidence of the beam on a surface of the workpiece controllably changes to drill the hole with a desired hole geometry.

2. The laser drilling system of claim 1, wherein the laser head, stage and galvo-mirror unit are controlled so that the beam spot and location are in a fixed spatial relationship during the pulse duration of the laser beam during the continuous relative displacement between the stage and laser head.

3. The laser drilling system of claim 2, wherein the laser source is configured with a delivery fiber having a uniform single core guiding and outputting the laser beam which drills a plurality round uniformly-dimensioned holes each defined by a cylindrical peripheral wall within the workpiece.

4. The laser drilling system of claim 2, wherein the laser source includes
at least one central laser outputting a first beam and a plurality of peripheral lasers surrounding the central laser and outing respective second beams, and
a double-clad delivery fiber having a central core which guides the first beam and outputting a ring-shaped beam incident on the surface of the workpiece, and an outer core receiving the second beams and outing a donut-shaped beam spot incident on the surface, the central and peripheral lasers being controllably operating to output the laser beam including only the ring-shaped beam or the donut-shaped beam or ring- and donut-shaped beams simultaneously.

5. The laser drilling system of claim 4, wherein the laser beam trepans a plurality of round holes in the workpiece.

6. The laser drilling system of claim 5, wherein a ratio between output powers of the central and peripheral lasers is controllably adjusted to have the peripheral walls each defining the round hole which is tapered at a desired taper angle.

7. The laser drilling system of claim 4, wherein the double-clad delivery fiber has a uniformly dimensioned cross-section or double bottleneck-shaped cross section along a fiber axis, the bottleneck cross-section having spaced fiber ends which flank a central fiber region and have respective diameters each smaller than that of the central fiber region.

8. The laser drilling system of claim 1, wherein the laser head is continuously displaceable while the stage is stationary, thereby preventing relative displacement between the workpiece and beam spot formed thereon as the galvo mirror unit pivots between the first and second positions.

9. The laser drilling system of claim 1, wherein the stage is actuated to continuously displace the workpiece, while the laser head remains stationary, thereby preventing relative displacement between the workpiece and beam spot formed thereon as the galvo mirror unit pivots between the first and second positions.

10. The laser drilling system of claim 1, wherein the laser head and stage both are actuated to provide continuous displacement between the laser head and workpiece while the beam spot and workpiece are displaceably fixed relative to one another as the galvo mirror unit pivots between the first and second positions at each location.

11. The laser drilling system of claim 1, wherein the galvo mirror unit is preprogrammed to provide drilling of a plurality of holes each defined by a peripheral wall, the peripherals walls each having a regular or irregular cross-section.

12. The laser drilling system of claim 11, wherein the regular cross-section includes annular or polygonal cross-section.
